(19) United States
(12) Patent Application Publication
(10) Pub. No.: US 2017/0150338 A1
(43) Pub. Date: May 25, 2017

(54) METHOD AND DEVICE HAVING PRUNING MECHANISM TO IDENTIFY WIRELESS ACCESS POINTS IN MULTIPLE-SSID ENVIRONMENT

(71) Applicant: SENAO NETWORKS, INC., Taoyuan City (TW)

(72) Inventors: Hao-Rung CHUNG, Taoyuan City (TW); Pei-Chuan LIU, Taoyuan City (TW); Yun-Hsuan HSIAO, Taoyuan City (TW)

(21) Appl. No.: 15/344,603

(22) Filed: Nov. 7, 2016

(30) Foreign Application Priority Data
Nov. 25, 2015 (TW) 104139143

(51) Int. Cl. H04W 8/00; H04L 29/12; H04B 17/318

(52) U.S. Cl. CPC H04W 8/005; H04B 17/318; H04L 61/6022; H04W 88/08

(57) ABSTRACT

A method having a pruning mechanism to identify wireless APs in multiple-SSID environment that includes the steps outlined below. (A) Wireless signal data in an environment are collected. (B) Only one of the at least two pieces of the wireless signal data having the same BSSID is kept and delete the at least one of the pieces of wireless signal data that has the BSSID derived from a MAC address of wireless APs under management. (C) Only one of the at least two pieces of the remained wireless signal data having the same channel, the same wireless mode, a difference of the RSSI absolute value that is smaller than a first predetermined value and a hamming distance of the BSSID that is smaller than a second predetermined value is kept. (D) Based on a number of the remained wireless signal, a number of the unmanaged wireless APs is determined.

### RELATED APPLICATIONS

This application claims priority to Taiwan Application Serial Number 104139143, filed on Nov. 25, 2015, which is herein incorporated by reference.

### BACKGROUND

Field of Disclosure

The present disclosure relates to a method and a device having a pruning mechanism to identify wireless access points in multiple-SSID environment. More particularly, the present disclosure relates to a method and a device having a pruning mechanism to identify wireless access points in multiple-SSID environment based on a BSSID value.

Description of Related Art

Currently, the function of detection of the wireless signal in the environment mostly displays the detection result directly or utilizes the detection result as parameters in other applications. No function of filtering or reducing the data amount of the wireless signals is provided. However, under the condition that there are many wireless APs in the environment and a function of multiple-SSID is activated, it is difficult for the network administrator or the wireless AP to determine that whether the detected wireless signals are from the same wireless AP. As a result, when there are more wireless signals in the environment, it is more difficult to analyze the large amount of detected wireless signal data and determine the wireless APs that physically exist. The management of the wireless APs becomes difficult.

### SUMMARY

As a result, an aspect of the present invention is to provide a method having a pruning mechanism to identify wireless access points (APs) in multiple-SSID environment that includes the steps outlined below. (A) A plurality pieces of wireless signal data in an environment are collected by an identification device. (B) Based on an information of basic service set identification (BSSID) included in the pieces of wireless signal data, at least two pieces of the wireless signal data that have the same BSSID by the identification device are determined to keep only one of the at least two pieces of the wireless signal data, and at least one of the pieces of wireless signal data in which the BSSID is derived from a media access control (MAC) address of at least one of wireless APs under management is determined based on data comprised in the pieces of wireless signal data to delete the at least one of the pieces of wireless signal data. (C) Based on information of a channel, a wireless mode, a received signal strength indicator (RSSI) and the BSSID of the remained wireless signal data after step (B), at least two pieces of the remained wireless signal data that have the same channel, the same wireless mode, a difference of the RSSI absolute value that is smaller than a first predetermined value and a hamming distance of the BSSID that is smaller than a second predetermined value are determined by the identification device to keep only one of the at least two pieces of the remained wireless signal data. (D) Based on a number of the pieces of the remained wireless signal data after step (C), a number of the unmanaged wireless APs that exist in the environment corresponding to the number of the pieces of the wireless signal data is determined by the identification device.

In an embodiment of the present invention, in step (A), the identification device detects the wireless signal in the environment to collect the pieces of wireless signal data.

In an embodiment of the present invention, in step (A), the pieces of wireless signal data are detected and provided to the identification device by at least one managed wireless AP.

In an embodiment of the present invention, the first predetermined value is 10 dBm, and the second predetermined value is 3.

In an embodiment, a device having a pruning mechanism to identify wireless APs in multiple-SSID environment wireless AP for realizing the method mentioned above that includes a signal collecting module and a processing module is provided. The signal collecting module is configured to collect a plurality pieces of wireless signal data in an environment. The processing module is configured to, based on an information of BSSID comprised in the pieces of wireless signal data, determine that at least two pieces of the wireless signal data have the same BSSID by the identification device to keep only one of the at least two pieces of the wireless signal data, to determine at least one of the pieces of wireless signal data in which the BSSID is derived from a MAC address of at least one of wireless APs under management based on data comprised in the pieces of wireless signal data to delete the at least one of the pieces of wireless signal data, based on information of a channel, a wireless mode, a received signal strength indicator (RSSI) and the BSSID of the remained wireless signal data, to determine that at least two pieces of the remained wireless signal data have the same channel, the same wireless mode, a difference of the RSSI absolute value that is smaller than a first predetermined value and a hamming distance of the BSSID that is smaller than a second predetermined value by the identification device to keep only one of the at least two pieces of the remained wireless signal data and, based on a number of the pieces of the remained wireless signal data, to determine a number of the unmanaged wireless APs that exist in the environment corresponding to the number of the pieces of the wireless signal data by the identification device.

In an embodiment of the present invention, the identification device detects the wireless signal in the environment to collect the pieces of wireless signal data.

In an embodiment of the present invention, the pieces of wireless signal data are detected and provided to the identification device by at least one managed wireless AP.

In an embodiment of the present invention, the first predetermined value is 10 dBm, and the second predetermined value is 3.

These and other features, aspects, and advantages of the present disclosure will become better understood with reference to the following description and appended claims.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a flow chart of a method having a pruning mechanism to identify wireless APs in multiple-SSID environment in an embodiment of the present invention; and

FIG. 2 is a block diagram of main components of a device having a pruning mechanism to identify wireless APs in multiple-SSID environment in an embodiment of the present invention.

### DETAILED DESCRIPTION

In order to make the objects, technical solutions and advantages of the present disclosure apparent, diagrams in combination of examples are used to describe the present disclosure in further detail. It should be understood that the specific embodiments described herein are merely examples for explaining the present disclosure and are not intended to limit the present disclosure.

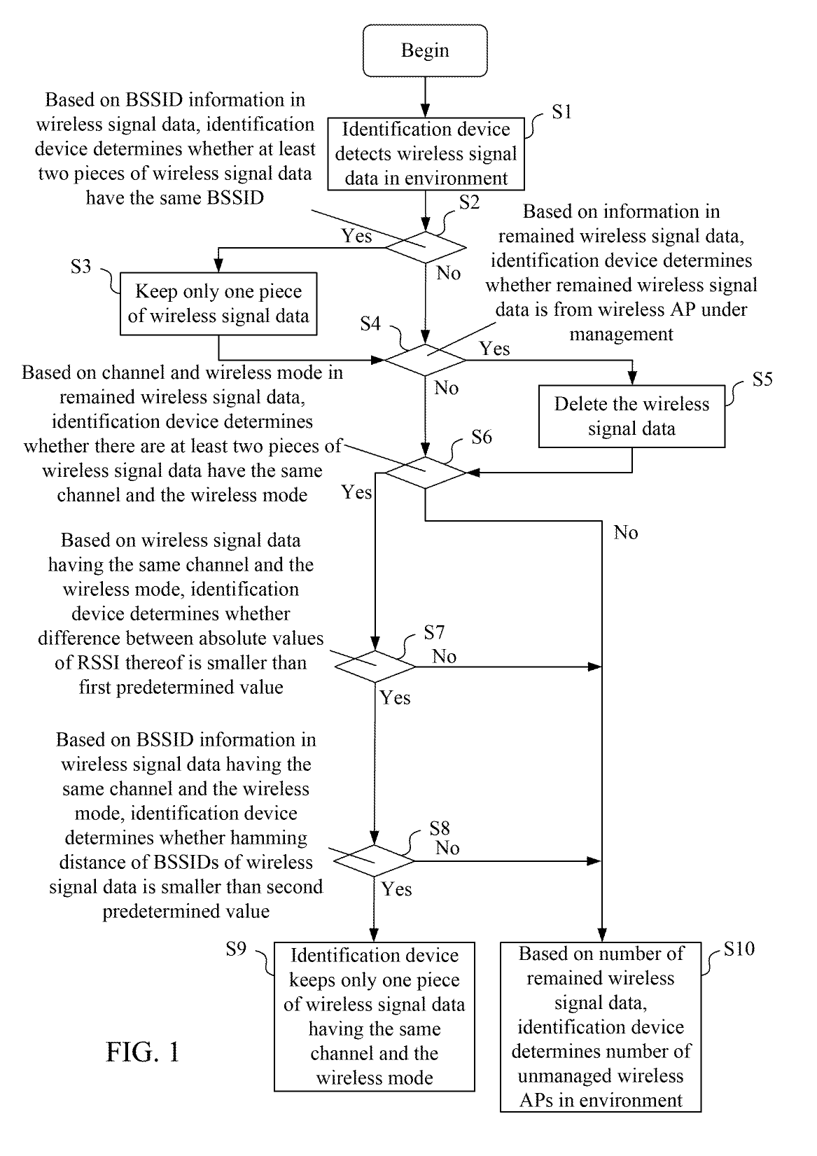

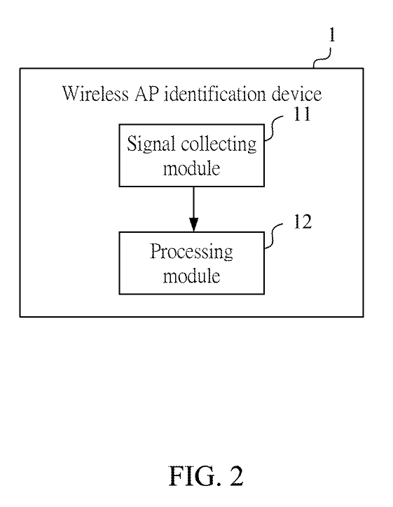

Reference is now made to FIG. 1 and FIG. 2 at the same time. In an embodiment, the wireless AP identification in the present invention is realized by a wireless AP identification device (abbreviated as identification device 1 in the following description). The identification device 1 mainly includes a signal collecting module 11 and a processing module 12. The identification device 1 can be a personal computer or other electronic devices that have similar operation functions. The signal collecting module 11 mainly includes a signal receiver that utilizes current wireless technologies and a storage media (e.g. a memory), and the processing module 12 is a signal processor that executes a software program or a firmware to perform the wireless AP identification flow described below.

Since each one of wireless APs has a unique basic service set identifier (BSSID, which is a unique identifier of each of the wireless APs. As a result, BSSID is the MAC address of the wireless network card each of the wireless APs), and that when a function of multiple-BSSID of a single wireless AP (if the function is available) is activated to simulate a plurality of virtual wireless APs, only a few bits of the BSSIDs are different among the BSSIDs of a plurality pieces of the wireless signals of the virtual wireless APs (included in the same physical wireless AP) since the BSSIDs of the virtual wireless APs are derived from the MAC address of the same physical wireless AP.

Besides, when a function of multiple-SSID is activated by a single wireless AP to establish a plurality of the virtual wireless APs such that the user connects to different wireless area network, the channel and the wireless mode included in each of the wireless signals from the virtual wireless APs are the same since the virtual wireless APs still utilize the same channel and the same wireless mode. Further, the difference among the absolute values of RSSI of the wireless signals of the virtual wireless APs is smaller than a predetermined range. As a result, in the present embodiment, the characteristic information (BSSID, SSID, RSSI, channel and the wireless mode, etc.) included in the wireless signals delivered by the wireless APs described above is used to identify the unmanaged wireless APs and the number thereof in the environment.

As a result, as illustrated in FIG. 1, at first, the wireless AP identification method in the present embodiment performs step S1 such that a signal collecting module 11 detects wireless signals in an environment to collect a plurality pieces of wireless signal data delivered by the wireless APs in the environment, such as the data illustrated in TABLE 1 illustrated below. Further, in the present embodiment, the pieces of wireless signal data can be detected and provided to the signal collecting module 11 of the identification device 1 by at least one managed wireless AP in the environment. Furthermore, according to TABLE 1 illustrated below, each piece of wireless signal data at least includes the information of BSSID, SSID, channel, RSSI and wireless mode.

TABLE 1

| | | | | Wireless |
|---|---|---|---|---|
| BSSID | SSID | Channel | RSSI | mode |
| A6:3B:FA:30:00:2F | abcxyz | 1 | −79 | 11g/n |
| 9E:4D:EA:04:70:BB | dog-cat | 6 | −66 | 11g/n |
| 00:02:6F:C9:AF:18 | Meeting Room 201 | 11 | −82 | 11b/g |
| 01:02:6F:CA:AF:19 | Meeting Room 306 | 11 | −80 | 11b/g |
| A6:3B:FA:30:00:2F | abcxyz | 1 | −72 | 11g/n |
| B0:48:7A:CE:65:82 | J-Hack | 3 | −87 | 11b/g |
| B0:48:7A:CE:66:82 | Home | 3 | −92 | 11b/g |
| 8E:4D:EA:04:70:6B | free | 6 | −62 | 11g/n |

Subsequently, as illustrated in step S2 in FIG. 1, since a single wireless AP has a unique BSSID, based on the BSSID information included in the pieces of the wireless signal data in TABLE 1 described above, the processing module 12 of the identification device 1 determines that whether at least two pieces of the wireless signal data have the same BSSID. If there are at least two pieces of the wireless signal data having the same BSSID, such as the two pieces of the wireless signal data having the same BSSID in TABLE 2 illustrated below, such two pieces of the wireless signal data are actually from the same wireless AR Step S3 is performed to delete one piece of the wireless signal data and keep only one of the wireless signal data, as illustrated in TABLE 2, such that the processing module 12 performs step S4 subsequently. Otherwise (when there is no wireless signal data having the same BSSID), the step S4 is directly performed without performing step S3.

TABLE 2

| | | | | Wireless |
|---|---|---|---|---|
| BSSID | SSID | Channel | RSSI | mode |
| A6:3B:FA:30:00:2F | abcxyz | 1 | −79 | 11g/n |
| 9E:4D:EA:04:70:BB | dog-cat | 6 | −66 | 11g/n |
| 00:02:6F:C9:AF:18 | Meeting Room 201 | 11 | −82 | 11b/g |
| 01:02:6F:CA:AF:19 | Meeting Room 306 | 11 | −80 | 11b/g |
| [symbol] | [symbol] | [symbol] | [symbol] | [symbol] |
| B0:48:7A:CE:65:82 | J-Hack | 3 | −87 | 11b/g |
| B0:48:7A:CE:66:82 | Home | 3 | −92 | 11b/g |
| 8E:4D:EA:04:70:6B | free | 6 | −62 | 11g/n |

Since the BSSID of the managed wireless APs are recorded by the network administrator when the equipments are bought or are calculated based on the MAC address of the wireless APs when the identification device 1 performs management (Usually, the MAC address of the wireless network card of the wireless AP can be derived and calculated according to the MAC of the Ethernet network card therefore. Though the calculating methodology of the MAC of the wireless APs from different manufacturers is different, the MAC and the BSSID derived from each of the wireless APs under management can be calculated by the identification device 1), based on the detected BSSID, the identification device 1 determines whether the wireless APs in the environment are managed. As a result, in step S4, based on the BSSID information included in the pieces of the remained wireless signal data in TABLE 2 illustrated above, the processing module 12 determines that whether there is at least one piece of the remained wireless signal data from at least one wireless AP that is under management. For example, two wireless APs in the environment are under management. The BSSIDs thereof are either recorded by the network administrator or calculated when the identification device 1 performs management and are 00:02:6F:C9:AF:18 and 01:02:6F:CA:AF:19 respectively. According to the information in TABLE 2 illustrated above, there are two wireless APs are under management in the environment. Since the two wireless APs under management are not the targets to be found in the present embodiment, the processing module 12 performs step S5 to delete such two pieces of wireless signal data, as illustrated in TABLE 3, such that the processing module 12 performs step S6 subsequently. Otherwise (when there is no wireless signal data from the managed wireless APs), the step S6 is directly performed without performing step S5.

TABLE 3

| | | | | Wireless |
|---|---|---|---|---|
| BSSID | SSID | Channel | RSSI | mode |
| A6:3B:FA:30:00:2F | abcxyz | 1 | −79 | 11g/n |
| 9E:4D:EA:04:70:BB | dog-cat | 6 | −66 | 11g/n |
| [symbol] | [symbol] | [symbol] | [symbol] | [symbol] |
| [symbol] | [symbol] | [symbol] | [symbol] | [symbol] |
| B0:48:7A:CE:65:82 | J-Hack | 3 | −87 | 11b/g |
| B0:48:7A:CE:66:82 | Home | 3 | −92 | 11b/g |
| 8E:4D:EA:04:70:6B | free | 6 | −62 | 11g/n |

It is worth to mention that steps S2 and S4 can be interchanged too. In other words, step S4 can be performed first to determine that whether there is at least one BSSID of the wireless signal data is derived from the MAC address of the at least one wireless AP under management. Subsequently, step S2 is performed to determine whether there are at least two pieces of wireless signal data having the same BSSID.

Further, even when a function of multiple-SSID of a single wireless AP is activated to establish a plurality of virtual wireless APs, the virtual wireless APs still utilize the same channel and the same wireless mode, and the difference among the absolute values of RSSI of the wireless signals of the virtual wireless APs is smaller than a predetermined range. Furthermore, when a function of multiple-BSSID of a single wireless AP is activated to simulate a plurality of virtual wireless APs, only a few bits of the BSSIDs are different among the BSSIDs of the pieces of wireless signals of the virtual wireless APs. As a result, in step S6, based on the channel and the wireless mode included in the pieces of the remained wireless signal data in TABLE 3 illustrated above, the processing module 12 determines that whether there are at least two pieces of wireless signal data having the same channel and the wireless mode. If there is no wireless signal data having the same channel and the wireless mode (which represents that the pieces of wireless signal data are from different wireless APs), the flow directly goes to step S10. If there are at least two pieces of wireless signal data having the same channel and the wireless mode, such as the two pieces of wireless signal data having the same channel 6 and the wireless mode 11g/n and the two pieces of wireless signal data having the same channel 3 and the wireless mode 11b/g in TABLE 4 illustrated below, step S7 is performed to further determine whether the difference between the absolute values of RSSI of the wireless signals utilizing the same channel 6 and the wireless mode 11g/n is smaller than a first predetermined value, e.g. 10. If the difference is not smaller than 10, the step S10 is performed. If the difference is smaller than 10, such as when the difference of the absolute values of RSSI of such two wireless signals is 4 (which is smaller than 10) in TABLE 4 illustrated below, step S8 is performed to further determine that whether the hamming distance of the BSSIDs of the two pieces of wireless signal data utilizing the same channel 6 and the wireless mode 11g/n is smaller than a second predetermined value by the identification device, e.g. 3. If the hamming distance of the BSSIDs of the two pieces of wireless signal data is not smaller than 3, the step S10 is performed. If the difference is smaller than 3, such as the hamming distance of the BSSIDs of the two pieces of wireless signal data is 2 (which is smaller than 3) in TABLE 4 illustrated below, the two pieces of wireless signal data are determined to be from the same wireless AP and step S9 is performed to keep only one piece of wireless signal data and delete the other piece of wireless signal data, as illustrated in TABLE 4.

TABLE 4

| | | | | Wireless |
|---|---|---|---|---|
| BSSID | SSID | Channel | RSSI | mode |
| A6:3B:FA:30:00:2F | abcxyz | 1 | −79 | 11g/n |
| 9E:4D:EA:04:70:BB | dog-cat | 6 | −66 | 11g/n |
| B0:48:7A:CE:65:82 | J-Hack | 3 | −87 | 11b/g |
| [symbol] | [symbol] | [symbol] | [symbol] | [symbol] |
| [symbol] | [symbol] | [symbol] | [symbol] | [symbol] |

Similarly, in step S7 and S8, the processing module 12 determines that the difference between the absolute values of RSSI (5) of the two pieces of wireless signal data having the same channel 3 and the wireless mode 11b/g is smaller than the first predetermined value (10), and the hamming distance of the BSSIDs (1) of the two pieces of wireless signal data is smaller than the second predetermined value (3). As a result, as illustrated in TABLE 4 above, in step S9, the processing module 12 keeps only one of the pieces of wireless signal data and deletes the other one of the pieces of wireless signal data. Subsequently, step S10 is performed. It is worth to mention that step S7 and step S8 can be interchanged as well. In other words, step S8 is performed first and step S7 is performed subsequently.

Finally, as illustrated in step S10, based on a number of the pieces of the remained wireless signal data in TABLE 5 illustrated below, the processing module 12 determines that there are three unmanaged wireless APs in the environment.

TABLE 5

| | | | | Wireless |
|---|---|---|---|---|
| BSSID | SSID | Channel | RSSI | mode |
| A6:3B:FA:30:00:2F | abcxyz | 1 | −79 | 11g/n |
| 9E:4D:EA:04:70:BB | dog-cat | 6 | −66 | 11g/n |
| B0:48:7A:CE:65:82 | J-Hack | 3 | −87 | 11b/g |

As a result, the identification device 1 is able to efficiently identify the unmanaged wireless APs in the environment and determine the unmanaged wireless APs that has been installed on the network without explicit authorization from the network administrator, as the rogue APs. The security of the network can be maintained.

In an application scenario, the identification device 1 may be disposed in the computer system equipped with a display panel (not illustrated). The processing module 12 thereof is able to control the display panel to either display a folded list showing only the wireless APs remained after the end the flow described above, or display an unfolded list showing all the detected wireless APs.

In conclusion, by collecting the wireless signal data in the environment and based on some characteristic information (BSSID, SSID, channel, RSSI and wireless mode) included in the wireless signal delivered by the wireless APs, the wireless signals delivered by the same wireless AP or by the managed wireless AP can be efficiently filtered in the above embodiment. Based on the number of the wireless signals after filtering, the unmanaged wireless APs and the number thereof in the environment can be efficiently identified to accomplish the effect and the object of the present invention.

It will be apparent to those skilled in the art that various modifications and variations can be made to the structure of the present disclosure without departing from the scope or spirit of the disclosure. In view of the foregoing, it is intended that the present disclosure covers modifications and variations of this disclosure provided they fall within the scope of the following claims.

What is claimed is:

1. A method having a pruning mechanism to identify wireless access points (APs) in multiple-SSID environment comprising:
(A) collecting a plurality pieces of wireless signal data in an environment by an identification device;
(B) based on an information of basic service set identification (BSSID) comprised in the pieces of wireless signal data, determining that at least two pieces of the wireless signal data have the same BSSID by the identification device to keep only one of the at least two pieces of the wireless signal data, and determining at least one of the pieces of wireless signal data in which the BSSID is derived from a media access control (MAC) address of at least one of wireless APs under management based on data comprised in the pieces of wireless signal data to delete the at least one of the pieces of wireless signal data;
(C) based on information of a channel, a wireless mode, a received signal strength indicator (RSSI) and the BSSID of the remained wireless signal data after step (B), determining that at least two pieces of the remained wireless signal data have the same channel, the same wireless mode, a difference of the RSSI absolute value smaller than a first predetermined value and a hamming distance of the BSSID smaller than a second predetermined value by the identification device to keep only one of the at least two pieces of the remained wireless signal data; and
(D) based on a number of the pieces of the remained wireless signal data after step (C), determining a number of the unmanaged wireless APs that exist in the environment by the identification device, in which the number of the unmanaged wireless APs corresponds to the number of the pieces of the remained wireless signal data.

2. The method of claim 1, wherein in step (A), the identification device detects the wireless signal in the environment to collect the pieces of wireless signal data.

3. The method of claim 1, wherein in step (A), the pieces of wireless signal data are detected and provided to the identification device by at least one managed wireless AP.

4. The method of claim 1, wherein the first predetermined value is 10 dBm, and the second predetermined value is 3.

5. A device having a pruning mechanism to identify wireless APs in multiple-SSID environment comprising:
a signal collecting module configured to collect a plurality pieces of wireless signal data in an environment; and
a processing module configured to, based on an information of BSSID comprised in the pieces of wireless signal data, determine that at least two pieces of the wireless signal data have the same BSSID by the identification device to keep only one of the at least two pieces of the wireless signal data, to determine at least one of the pieces of wireless signal data in which the BSSID is derived from a MAC address of at least one of wireless APs under management based on data comprised in the pieces of wireless signal data to delete the at least one of the pieces of wireless signal data, based on information of a channel, a wireless mode, a received signal strength indicator (RSSI) and the BSSID of the remained wireless signal data, to determine that at least two pieces of the remained wireless signal data have the same channel, the same wireless mode, a difference of the RSSI absolute value smaller than a first predetermined value and a hamming distance of the BSSID smaller than a second predetermined value by the identification device to keep only one of the at least two pieces of the remained wireless signal data and, based on a number of the pieces of the remained wireless signal data, to determine a number of the unmanaged wireless APs that exist in the environment corresponding to the number of the pieces of the wireless signal data by the identification device.

6. The device of claim 5, wherein the identification device detects the wireless signal in the environment to collect the pieces of wireless signal data.

7. The device of claim 5, wherein the pieces of wireless signal data are detected and provided to the identification device by at least one managed wireless AP.

8. The device of claim 5, wherein the first predetermined value is 10 dBm, and the second predetermined value is 3.
